(19) United States
(12) Patent Application Publication
(10) Pub. No.: US 2006/0194683 A1
(43) Pub. Date: Aug. 31, 2006

(54) Processing of a filter material band in the tobacco industry

(75) Inventors: Jorg Tobias, Drage (DE); Franz-Peter Koch, Schwarzenbek (DE); Sonke Horn, Geesthacht (DE)

Correspondence Address: VENABLE LLP, P.O. BOX 34385, WASHINGTON, DC, 20045-9998, US

(73) Assignee: Hauni Maschinenbau Ag, Hamburg (DE)

(21) Appl. No.: 11/354,187

(22) Filed: Feb. 15, 2006

(30) Foreign Application Priority Data
Feb. 16, 2005 (DE) 10 2005 007 214.3

(51) Int. Cl. B31C 13/00

(52) U.S. Cl. 493/39

(57) ABSTRACT

A method and apparatus are disclosed for processing a band of filter material in the tobacco industry. The band is conveyed to a stretching section of a stretching device or to an application section of an application device. A first roller arrangement comprising at least two rollers is disposed on an intake side of the stretching section or the application section, and a second roller arrangement comprising at least two rollers is disposed on an outlet side of the stretching section or the application section. The band is conveyed while looped around at least two rollers of the first or the second roller arrangement so that the band is respectively looped at least partially around the rollers.

### CROSS-REFERENCE TO RELATED APPLICATION

This application claims the priority of German Application No. 10 2005 007 214.3, filed on Feb. 16, 2005, the subject matter of which is incorporated herein by reference.

### BACKGROUND OF THE INVENTION

The invention relates to a method and an apparatus for processing a filter material band in the tobacco industry, wherein the band is conveyed to a stretching section of a stretching device and/or to an application section of an application device. A first roller arrangement comprising at least two rollers is provided on the intake side of the stretching section and/or the application section and a second roller arrangement comprising at least two rollers is provided on the outlet side of the stretching section and/or the application section.

To produce filter rods in the tobacco industry, a filter material band, in particular filter tow, of connected fibers such as cellulose acetate is pulled continuously from a supply such as a bale, is then spread out, is stretched, and is sprayed with a softener, such as triacetin. The band is reduced on the sides, is moved to a nozzle blowing out air and is subsequently fed to a funnel from which the processed and compacted filter band is supplied to a continuous filter rod maker. In a filter rod maker, the rod-shaped band is wrapped continuously with a wrapping material strip while being compacted or reduced further. Following this, individual filter rods are cut from the wrapped continuous rod.

Proven processing machines of the above-described type are manufactured and marketed by the Hauni Maschinenbau AG, Hamburg, Germany, under the trade names AF 2, AF 3, and AF 4. Proven continuous filter rod makers of the above-described type are manufactured and marketed by Hauni Maschinenbau under the trade names KDF 2, KDF 3, and KDF 4.

German patent document DE-A-44 43 866 furthermore discloses an apparatus for shaping a filter tow rod in the tobacco industry. With this apparatus, a filter-tow band is spread out, is processed, and is then reduced to form a continuous filter tow rod. The continuous filter tow rod produced in this way is guided in a movement plane from which it is deflected to the side before reaching a machine for further processing, and into which it is guided back following the deflection. The deflection of the formed continuous filter tow rod avoids tow split in the continuous filter tow rod.

An arrangement for processing a filter material band in the tobacco industry is also disclosed in European patent document EP-B-0 654 224. A different apparatus of the generic type is disclosed is also disclosed in European patent document EP-A-1 106 087.

### SUMMARY OF THE INVENTION

Starting with this prior art, it is an object of the present invention to reduce or even avoid wear on the surfaces of roller pairs used in a stretching and/or application section for processing a filter material band.

The above and other objects are achieved according to the invention by the provision of a method for processing a band of filter material in the tobacco industry, comprising: conveying the band to at least one of a stretching section of a stretching device or to an application section of an application device, wherein a first roller arrangement comprising at least two rollers is disposed on an intake side of at least one of the stretching section or the application section, and a second roller arrangement comprising at least two rollers is disposed on an outlet side of at least one of the stretching section or the application section; and conveying the band while looped around at least two rollers of the first or the second roller arrangement so that the band is respectively looped at least partially around the rollers.

The invention is based on the idea that the rollers of a stretching device and/or an application device convey a band of filter tow, wrapped in a large loop around at least two rollers. In contrast to the prior art, the invention proposes that the filter tow band is wrapped around and/or partially encloses both rollers of a roller pair, so that it is no longer necessary for the two rollers of a roller pair to make contact. Rather, the filter tow band according to the invention is guided while in contact with the rollers either by being looped around or fitted in an S-shape around the rollers of a roller pair or a roller arrangement. As a result of the spacing between the rollers, a gap is created between the rollers, thus preventing the rollers from making contact and consequently also preventing frictional wear of the roller surfaces. The filter tow band can be guided in a stretching section of a stretching device as well as in an application section of an application device for a filter tow processing machine, respectively on the intake side and/or the outlet side, by looping and/or wrapping the filter tow band around the rollers. On the whole, the frictional wear of the surface of a rubber-coated roller is thus reduced by the loop-shaped guidance of the filter tow band.

It is understood that the roller area around which the band is looped is the curved section of a roller in which the material band is conveyed while fitting flush against the rounded surface of the roller. For example, the band is looped around several rollers of a roller arrangement or a roller pair, which thus form a complete unit. The angle for looping the band around a roller can also be less than 45° or 30° in that case, wherein, in cooperation with the preceding or following roller or with additional rollers, the complete angle for looping the band around the roller arrangement is essentially equal to or larger than 180°. According to one embodiment, the material band is looped around at least one roller of the roller arrangement at an angle of nearly or at least 180°.

The at least partial looping of the material band around the rollers of a roller arrangement results in multiple curve-like deflections of the band since the material band fits against each roller by being partially wrapped around it, meaning with a curvature.

For a reliable guidance of the filter tow band, it is provided that at least two rollers of the first and/or the second roller arrangement are driven with the same predetermined number of revolutions and/or the same rotational speed or circumferential speed.

According to one alternative embodiment, it is proposed that at least two rollers of the first and/or the second roller arrangement are respectively driven with different numbers of revolutions and/or rotational speeds or circumferential speeds, for example to cause a pre-stretching of the filter material band on the intake side of the stretching section.

According to yet another embodiment, the at least two rollers of the first and/or the second roller arrangement are driven so as to make contact.

In another exemplary embodiment of the method, at least two rollers of the first and/or the second roller arrangement are driven without making contact, thus preventing any wear of the roller surface.

The conveyed filter tow band is made more pliable for the processing if at least one roller of the first and/or the second roller arrangement is heated. Heated rollers reduce the destruction of the fibers in a filter material band. Within the scope of the present disclosure, it is conceivable to heat the rollers of existing roller arrangements according to know techniques. The heating of rollers as described for the present case is not limited to the subject matter of the present invention.

According to yet another exemplary embodiment, dust may be removed from the first and/or the second roller arrangement, in particular from at least one roller, so that particles interfering with the processing are removed from the area of processing. This improves the quality of the triacetin application to the filter tow even further.

For the dust removal, air and in particular compressed air may be blown out of at least one roller of the first and/or the second roller arrangement. The air exiting from a roller is correspondingly suctioned off the roller with the aid of a suctioning device, thus reliably removing particles adhering to the roller surface.

It is furthermore advantageous if air is suctioned into at least one roller of the first and/or the second roller arrangement, thereby improving the adherence of the conveyed filter tow band to the roller surface.

Changing or adapting the spacing between at least two rollers of the first and/or the second roller arrangement is also favorable, wherein the rollers can be adjusted to meet the requirements for the continuous filter tow rod produced from the processed filter band, thereby adjusting predetermined settings for the stretching of the filter tow band on a stretching device and/or an application device.

In further exemplary embodiments, the band may be conveyed with the aid of either profiled and/or non-profiled rollers of the first and/or the second roller arrangement. As a result, a multi-stage stretching can be realized on a stretching device in order to adjust the conveying of the band while simultaneously improving the stretching of the band.

According to another aspect of the invention there is provided an apparatus for processing a band of filter material in the tobacco industry, comprising: at least one of a stretching device having a stretching section or an application device having an application section; a first roller arrangement comprising at least two rollers on an intake side of the stretching section of the stretching device or of the application section of the application device; and a second roller arrangement comprising at least two rollers on an outlet side of the stretching section of the stretching device or of the application section of the application device; wherein the band fits against at least two rollers of the first or the second roller arrangement, respectively, by being looped at least in part around the rollers.

A reliable conveying of the filter tow band is possible if the number of rotations and/or the rotational speeds or circumferential speeds of at least two rollers of the first and/or the second roller arrangement coincide.

In addition, a pre-stretching of the conveyed filter tow band can be achieved if the number of rotations or the circumferential speeds of at least two rollers of the first and/or the second roller arrangement differ.

It is furthermore proposed that at least two rollers of the first and/or the second roller arrangement are positioned such that they either make contact or do not make contact.

Favorable conditions for conveying the filter tow band can furthermore be adjusted if at least two rollers of the first and/or the second roller arrangement have different diameters.

A heating device may be provided for at least one roller of the first and/or the second roller arrangement to reduce the brittleness of the filter material.

The processing may also improved by providing a dust-removing device on at least one roller of the first and/or the second roller arrangement, for example in the form of a brush mounted on a roller, or even by subjecting the roller to ultrasound.

Dust can also be removed by providing bores in at least one roller of the first and/or the second roller arrangement through which compressed air or suction air can flow.

For the dust removal, the at least one roller of the first and/or the second roller arrangement may be subjected to compressed air or a low pressure creating suction.

According to one embodiment, it is furthermore provided that the spacing between at least two rollers of the first and/or the second roller arrangement can be changed and/or adapted.

In addition, at least one roller of the first and/or the second roller arrangement may be profiled or not profiled.

At least one roller or several rollers, or possibly all rollers, of the first and/or the second roller arrangement may be made of steel.

According to one another exemplary embodiment of the apparatus, the first and/or the second roller arrangement each comprises more than two rollers, for example, three or four rollers.

The objects of the invention may also be achieved with a machine used in the tobacco industry, especially a filter-material processing machine and/or a continuous filter rod maker provided utilizing an apparatus according to the invention, as described in the above.

### BRIEF DESCRIPTION OF THE DRAWINGS

The invention is explained in the following, without restricting the general inventive idea, by referring to the exemplary embodiments shown in the drawing, to which reference is made for all details not further mentioned in the specification.

FIG. 1 shows a diagram of a processing apparatus according to prior art.

FIGS. 2a, 2b show a view and a perspective view of a stretching device according to the invention.

FIGS. 3a, 3b show a view and a perspective representation of a different stretching device according to the invention.

FIG. 4 shows a view of yet another stretching device according to the invention as well as an application device.

### DETAILED DESCRIPTION OF THE PREFERRED EMBODIMENTS

The same elements or corresponding parts are provided with the same reference numbers in the following Figures and will not be introduced again.

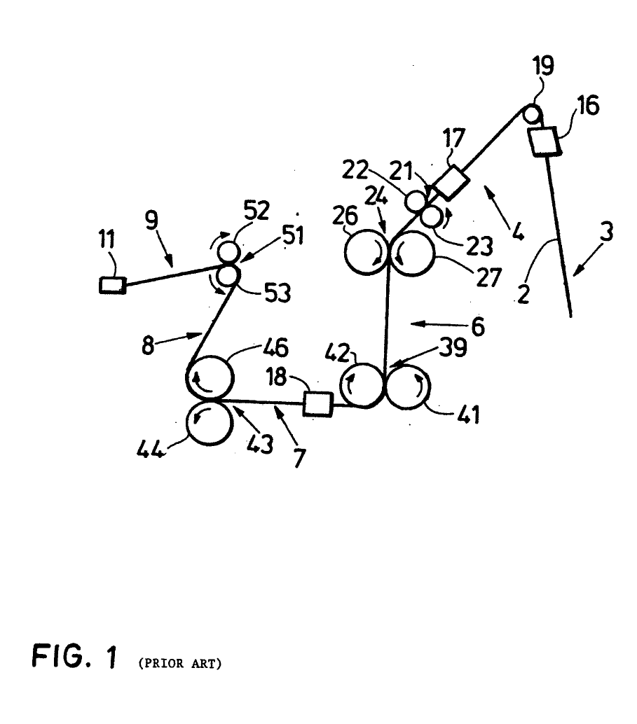

According to FIG. 1, an apparatus for processing a filter tow band 2 of coherent fibers such as cellulose acetate, pulled from a bale, comprises the following main components through which the band 2 passes successively: a withdrawing section 3, a pre-stretching section 4, a stretching section 6, an application section 7, a reducing section 8, and a feeding section 9. The feeding section 9 is intended for feeding a portion of the band to an intake device of a schematically shown continuous filter rod maker 11, e.g. of the type KDF 2, KDF 3, or KDF 4 by Hauni Maschinenbau AG, which are known in the tobacco-processing industry.

The filter material band 2 that is pulled from a bale, not shown herein, is conveyed in the withdrawing section 3. The section is provided with a spreader nozzle 16, which serves to blow compressed air onto the band for spreading out the conveyed filter tow material in this section. A controllable spreader nozzle is described, for example, in U.S. Pat. No. 4,259,769.

The filter tow band 2 is conveyed via a deflection roller 19 to the pre-stretching section 4, which is defined on one end by a roller pair 21 with rollers 22, 23 and on other end by a roller pair 24 with motor-driven rollers 26, 27. The rollers 22, 23 are dragged by the tow band, meaning they run along with no load and more or less resistance. If necessary, rollers 22, 23 can be operated with a motor. They can also be pressed against each other with a controllable force, in a manner known per se.

The filter tow 2 is pre-stretched in the pre-stretching section 4, in which the section of the band is conveyed downward at an angle. A spreader nozzle 17 is furthermore arranged in the pre-stretching section 4 for spreading out the conveyed filter tow 2 before it enters the stretching section 6.

The roller pair 24 is followed by the stretching section 6 in which the filter tow band 2 is conveyed either vertically or with a vertical component, from the top to the bottom. An additional roller pair 39 with motor-driven rollers 41, 42 is arranged at the end of the stretching section 6, wherein these motor-driven rollers operate at a slightly higher circumferential speed than the rollers 26, 27, so that the elastic filter tow is subjected to a defined stretching. The roller pairs 24 and 39 thus form the actual stretching device.

The rollers 26 and 41 have a rigid, grooved surface, which respectively come in contact with a resilient surface of the rollers 27 and 42. Roller configurations of this type are known from the previously mentioned filter tow processing machines AF2, AF3, and AF4 and are described, for example, in U.S. Pat. Nos. 3,317,965 and 3,255,506.

In the application section 7, the roller pair 39 is followed by a different roller pair 43, for which the circumferential speed is lower than that of the rollers 41, 42, so that the filter tow 2 relaxes slightly while it is conveyed in the application section 7. The roller pair 43 also comprises a roller 44 with a rigid, grooved surface that comes in contact with the resilient surface of rollers 46.

The roller pairs 39 and 43 thus delimit the application section 7, which is arranged nearly horizontal for the present case and which comprises an application device in the form of a spraying device 18. The spraying device 18 can be designed as described in U.S. Pat. No. 4,313,974 and is used to spray finely-dispersed drops of a solvent, e.g. triacetin, onto one or both sides of the conveyed filter tow material. Alternatively, triacetin can also be sprayed onto the filter tow with the aid of nozzles, as described in European patent document EP-A-1 106 087.

The application section 7 is followed by a reducing section 8 in which the filter tow band 2 is conveyed with a mostly vertical component from the bottom toward the top, by a roller pair 51 of motor-driven rollers 52, 53. The roller 52 again has a rigid, grooved surface that makes contact with a roller having a resilient surface.

Following the roller pair 43, the filter tow band 2 is supplied to the reducing section 8 of a device (not shown) for reducing the width of the filter tow. Following the reducing section 8, the filter tow 2 is then supplied via the roller pair 51 to an intake for a continuous filter rod maker 11. For further details, reference is made to European patent document EP-B-0 654 224.

In the reducing section 8, which follows the application section 7, the filter tow band 2 is conveyed upward, either perpendicular or with a substantially perpendicular component, between the roller pair 43 and the roller pair 51. The reducing section 8 can comprise one or several successive (not shown herein) reducing devices in the form of wire loops, wherein these loops have decreasing diameters in the conveying direction of the filter tow band, thus also reducing the width of the filter tow band. As a result of reducing the filter tow band on the sides, a filter tow rod having a cross section that approaches the cross section of a continuous filter rod to be produced is created.

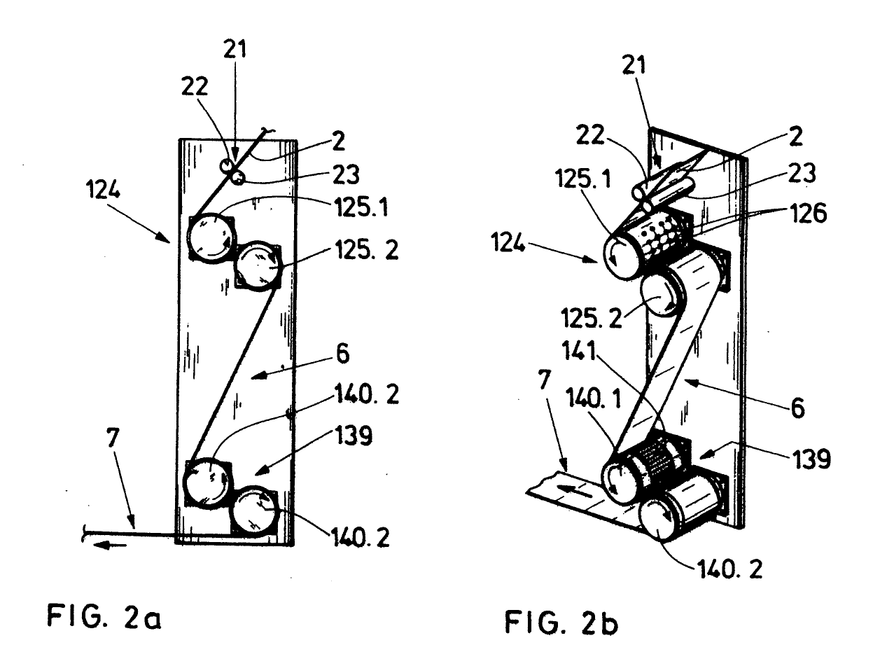

FIGS. 2a, 2b show different views of a stretching device according to the invention, which replaces the stretching device consisting of the roller pairs 24 and 39, shown in FIG. 1.

A roller arrangement 124, comprising the rollers 125.1 and 125.2, is provided on the intake side of the stretching section 6 instead of the roller pair 24 with rollers 26 and 27. A roller arrangement 139 with rollers 140.1 and 140.2 is arranged on the outlet side of the stretching section 6.

On the intake side, the filter tow band 2 is guided in the shape of an S or is looped around the rollers 125.1 and 125.2, wherein the rollers 125.1 and 125.2 do not come in contact with each other. As a result of the band being looped or wrapped around the rollers 125.1 and 125.2, the rotational direction of the rollers 125.1 and 125.2 differs from the rotational direction of the rollers 26, 27 shown in FIG. 1. In addition, the rollers 125.1 and 125.2 are arranged vertically offset in height, wherein the spacing between the rollers 125.1 and 125.2 can be adjusted.

For the present exemplary embodiment, the rollers 125.1 and 125.2 have the same diameter. Within the framework of this invention, however, it is conceivable to have different diameters for the rollers 125.1 and 125.2 and/or for the rollers of the other roller arrangements. In a further modification, the rollers of the respective roller arrangements can also be driven with different speeds, thus resulting in different circumferential speeds for the rollers.

The rollers 140.1 and 140.2 of the roller arrangement 139 on the outlet side of the stretching section 6 are also arranged offset to each other with respect to height and spacing. The filter tow band is furthermore also looped around the rollers 140.1 and 140.2, wherein the rollers 140.1 and 140.2 do not come in contact.

The perspective view according to FIG. 2b shows that the roller 125.1 is provided with suction bores 126 to allow generating a low pressure inside the roller 125.1. As a result, the air being sucked into the roller improves the adherence of the filter tow band 2 to the roller 125.1 and carries off loose particles.

FIG. 2b furthermore shows that the peripheral surface of roller 140.1 is a heated surface 141, which also heats the conveyed filter tow band 2. More flexible material properties are obtained on the whole, thus improving the application of triacetin onto the filter tow band.

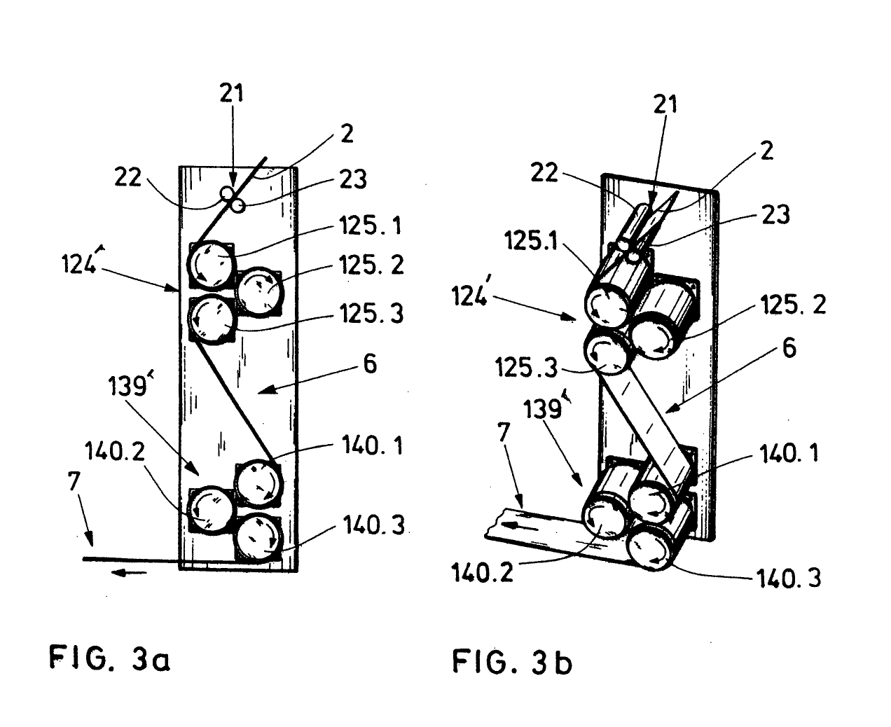

FIGS. 3a, 3b show another roller arrangement 124′ on the intake side and another roller arrangement 139′ on the outlet side, for the stretching section 6. The roller arrangements 124′ and 139′ respectively comprise three rollers 125.1 to 125.3 and 140.1 to 140.3, around which the filter tow band 2 is looped.

The filter tow band is pre-stretched between the rollers 125.1 and 125.2 and the rollers 125.2 and 125.3, even before the filter tow band enters the stretching section, if the rollers 125.1 to 125.3 are respectively driven with different speeds. On the outlet side of the reducing section 6, the rollers 140.1 to 140.3 are also arranged offset relative to each other while the filter tow band is looped around them.

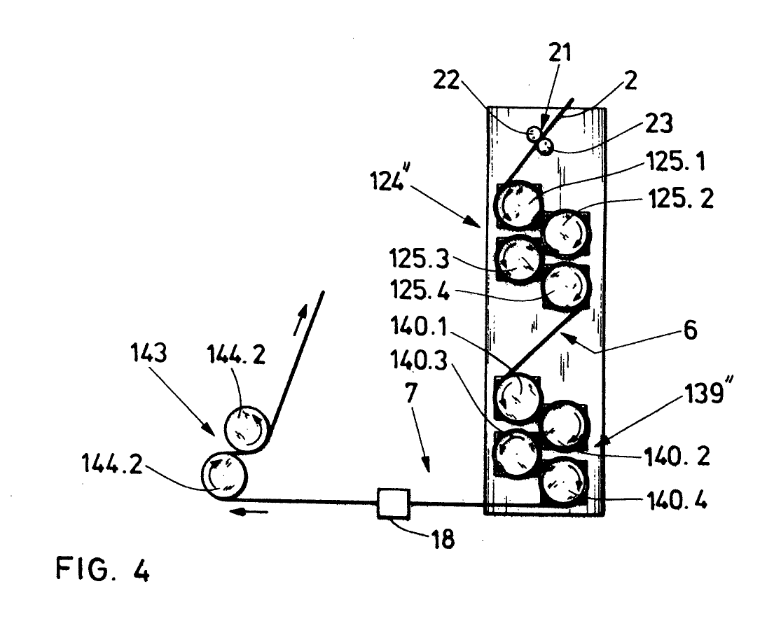

FIG. 4 shows a view of the stretching section 6 and the application section 7, wherein roller arrangements 124″ and 139″ respectively comprise four rollers. The roller arrangement 124″ comprises the rollers 125.1 to 125.4, of which respectively two rollers move in the same rotational direction. The filter tow band 2 is looped around the rollers 140.1 to 140.4 on the outlet side of the roller arrangement 139″, in the same way as it is looped around the rollers 125.1 to 125.4 on the intake side.

The roller arrangement 139″ on the outlet side of the stretching section 6 simultaneously forms the roller arrangement for the intake side of the application section 7. An additional roller arrangement 143 is arranged on the outlet side of the application section 7, which replaces the roller pair 43 shown in FIG. 1. The roller arrangement 143 of this exemplary embodiment comprises two rollers 144.1 and 144.2. Without restricting the general inventive idea, the roller arrangement 143 can also comprise additional rollers, around which the filter tow band is looped on the outlet side, as defined by the invention. The filter tow band is looped or wrapped around the rollers 144.1, 144.2 of the roller arrangement 143 on the outlet side of the application section 7, in the same way as the rollers of the roller arrangements 124 and 139.

Within the scope of this invention, it is possible that only the application section 7 is provided with roller arrangements, wherein the guided filter tow band is looped in an S-shape around the rollers of the roller arrangements.

It will be understood that the above description of the present invention is susceptible to various modifications, changes and adaptations, and the same are intended to be comprehended within the meaning and range of equivalents of the appended claims.

1. A method for processing a band of filter material in the tobacco industry, comprising:
conveying the band to at least one of a stretching section of a stretching device or to an application section of an application device, wherein a first roller arrangement comprising at least two rollers is disposed on an intake side of at least one of the stretching section or the application section, and a second roller arrangement comprising at least two rollers is disposed on an outlet side of at least one of the stretching section or the application section; and
conveying the band while looped around at least two rollers of the first or the second roller arrangement so that the band is respectively looped at least partially around the rollers.

2. The method as defined in claim 1, including driving at least two rollers of the first or the second roller arrangement with the same predetermined rotational speed.

3. The method as defined in claim 1, including driving at least two rollers of the first or the second roller arrangement with respectively different rotational speeds.

4. The method as defined in claim 1, driving at least two rollers of the first or the second roller arrangement so as to make contact.

5. The method as defined in claim 1, driving at least two rollers of the first or the second roller arrangement so that they do not come in contact.

6. The method as defined in claim 1, including heating at least one roller of the first or the second roller arrangement.

7. The method as defined in claim 1, including removing dust from at least one roller of the first or the second roller arrangement.

8. The method as defined in claim 1, including blowing air out of at least one roller of the first or the second roller arrangement.

9. The method as defined in claim 1, including suctioning in air by at least one roller of the first or the second roller arrangement.

10. The method as defined in claim 1, including adapting or changing a spacing between at least two rollers of the first or the second roller arrangement.

11. The method as defined in claim 1, including conveying the band by profiled or non-profiled rollers of the first or the second roller arrangement.

12. An apparatus for processing a band of filter material in the tobacco industry, comprising:
at least one of a stretching device having a stretching section or an application device having an application section;
a first roller arrangement comprising at least two rollers on an intake side of the stretching section of the stretching device or of the application section of the application device; and
a second roller arrangement comprising at least two rollers on an outlet side of the stretching section of the stretching device or of the application section of the application device;
wherein the band fits against at least two rollers of the first or the second roller arrangement, respectively, by being looped at least in part around the rollers.

13. The apparatus as defined in claim 12, wherein the circumferential speeds of at least two rollers of at least one of the first or the second roller arrangement coincide.

14. The apparatus as defined in claim 12, wherein the circumferential speeds of at least two rollers of at least one of the first or the second roller arrangement differ.

15. The apparatus as defined in claim 12, wherein at least two rollers of at least one of the first or the second roller arrangement are arranged so that they either make contact.

16. The apparatus as defined in claim 12, wherein at least two rollers of at least one of the first or the second roller arrangement are arranged so that they do not make contact.

17. The apparatus as defined in claim 12, wherein at least two rollers of at least one of the first or the second roller arrangement have different diameters.

18. The apparatus as defined in claim 12, further including a heating system for at least one roller of at lest one of the first or the second roller arrangement.

19. The apparatus as defined in claim 12, further including a dust-removing device for at least one roller of at least one of the first or the second roller arrangement.

20. The apparatus as defined in claim 12, further including compressed air or suction air bores in at least one roller of at least one of the first or the second roller arrangement.

21. The apparatus as defined in claim 20, wherein the at least one roller of at least one of the first or the second roller arrangement is admitted with compressed air or suction air.

22. The apparatus as defined in claim 12, wherein a spacing between at least two rollers of at least one of the first or the second roller arrangement is changeable or adaptable.

23. The apparatus as defined in claim 12, wherein at least one roller of at least one of the first or the second roller arrangement is profiled.

24. The apparatus as defined in claim 12, wherein at least one roller of at least one of the first or the second roller arrangement is not profiled.

25. The apparatus as defined in claim 12, wherein at least one roller of at least one of the first or the second roller arrangement is comprised of steel.

26. The apparatus as defined in claim 12, wherein at a plurality of rollers of at least one of the first or the second roller arrangement is comprised of steel.

27. The apparatus as defined in claim 12, wherein at least one of the first or the second roller arrangements respectively comprises more than two rollers.

28. The apparatus as defined in claim 12, wherein at least one of the first or the second roller arrangements respectively comprises three or four rollers.

29. A machine used in the tobacco-processing industry, comprising an apparatus according to claim 12.

30. A method of processing filter material in the tobacco-processing industry, comprising utilizing the apparatus according to claim 12.

31. A method of making a continuous filter rod in the tobacco-processing industry, comprising utilizing the apparatus according to claim 12.
